(19) United States
(12) Patent Application Publication
(10) Pub. No.: US 2021/0282410 A1
(43) Pub. Date: Sep. 16, 2021

(54) IMPROVER FOR SPONGE CAKE

(71) Applicant: J-OIL MILLS, INC., Tokyo (JP)

(72) Inventors: Mina YOSHIMURA, Tokyo (JP); Keisuke SHINODA, Tokyo (JP); Yuya NAGAHATA, Tokyo (JP); Daisuke NAGASAWA, Tokyo (JP); Jun IMAGI, Tokyo (JP)

(21) Appl. No.: 17/262,983

(22) PCT Filed: Jul. 26, 2019
(86) PCT No.: PCT/JP2019/029523

§ 371 Date: Jan. 25, 2021

(30) Foreign Application Priority Data
Aug. 3, 2018 (JP) 2018-147044
Oct. 19, 2018 (JP) 2018-197308

(51) Int. Cl. A21D 2/18; A21D 10/00; A21D 13/80; A21D 13/24; A21D 15/02

(52) U.S. Cl. CPC A21D 2/186; A21D 10/005; A21D 15/02; A21D 13/24; A21D 13/80

(57) ABSTRACT

An improver for a sponge cake includes a component (A) satisfying conditions of (1) to (5) below: (1) a starch content is equal to or more than 75% by mass; (2) equal to or more than 3% by mass and equal to or less than 45% by mass of molecular weight-reduced starch of starch having an amylose content of equal to or more than 5% by mass is contained, where the molecular weight-reduced starch has a peak molecular weight of equal to or more than 3×10³ and equal to or less than 5×10⁴; (3) a degree of swelling in cold water at 25° C. is equal to or more than 5 and equal to or less than 20; (4) a content under a sieve having a mesh size of 0.25 mm is equal to or more than 80% by mass and equal to or less than 100% by mass; and (5) a content on a sieve having a mesh size of 0.5 mm is equal to or less than 10% by mass.

### TECHNICAL FIELD

The present invention relates to an improver for a sponge cake.

### BACKGROUND ART

As a technique relating to an improver for cakes, there are those described in Patent Documents 1 and 2.

Patent Document 1 (Japanese Unexamined Patent Publication No. 2008-92941) describes a wet-heat-treated wheat flour for bakeries in which a degree of pregelatinization and a viscosity are in specific ranges, respectively. According to the same document, it is described that when using such a wheat flour, it is possible to provide the wet-heat-treated wheat flour for bakeries, that improves a volume of a product of bakeries and is capable of obtaining bakeries which have a fine inner layer, is soft, and has excellent moist feeling and melt feeling in-a-mouth, and further which can suppress dryness due to the dryness caused by dry or dryness caused by aging of starch, and can maintain a texture immediately after production, in other words, can have excellent resistance to aging, even in reheating cooking such as microwave cooking after storage at a normal temperature, chilled or frozen state, and it is possible to provide a bakery mix and bakeries using the wheat flour.

Patent Document 2 (Japanese Unexamined Patent Publication No. 2006-129789) describes cakes containing swelling-suppressed starch using small-particle starch as a raw material, and also describes that the cakes have an excellent texture of the internal phase and has a moist feeling, good meltability in mouth, a soft texture, in which deterioration over during frozen or refrigerated storage is improved.

### RELATED DOCUMENT

### Patent Document

[Patent Document 1] Japanese Unexamined Patent Publication No. 2008-92941

[Patent Document 2] Japanese Unexamined Patent Publication No. 2006-129789

### SUMMARY OF THE INVENTION

### Technical Problem

However, in a case where the technique described above is used, there is room for improvement in that a sponge cake having excellent meltability in mouth and suppressing dryness even after storage, and when the sponge cake is coated with a whipped cream, a decoration cake having an excellent balance of the meltability in mouth between the cream and the sponge cake.

### Solution to Problem

According to the present invention, there is provided an improver for a sponge cake including: a component (A) satisfying conditions of (1) to (5) below as an active ingredient.

(1) A starch content is equal to or more than 75% by mass;

(2) equal to or more than 3% by mass and equal to or less than 45% by mass of molecular weight-reduced starch of starch having an amylose content of equal to or more than 5% by mass is contained, where the molecular weight-reduced starch has a peak molecular weight of equal to or more than 3×10¹ and equal to or less than 5×10⁴;

(3) a degree of swelling in cold water at 25° C. is equal to or more than 5 and equal to or less than 20;

(4) a content under a sieve having a mesh size of 0.25 mm is equal to or more than 80% by mass and equal to or less than 100% by mass; and

(5) a content on a sieve having a mesh size of 0.5 mm is equal to or less than 10% by mass.

According to the present invention, there is provided a dough for a sponge cake including: a component (A) satisfying conditions of (1) to (5) below; and a powder raw material other than the component (A).

(1) A starch content is equal to or more than 75% by mass;

(2) equal to or more than 3% by mass and equal to or less than 45% by mass of molecular weight-reduced starch of starch having an amylose content of equal to or more than 5% by mass is contained, where the molecular weight-reduced starch has a peak molecular weight of equal to or more than 3×10³ and equal to or less than 5×10⁴; (3) a degree of swelling in cold water at 25° C. is equal to or more than 5 and equal to or less than 20;

(4) a content under a sieve having a mesh size of 0.25 mm is equal to or more than 80% by mass and equal to or less than 100% by mass; and

(5) a content on a sieve having a mesh size of 0.5 mm is equal to or less than 10% by mass

According to the present invention, there is provided a mixed flour for a sponge cake, including:

a component (A) satisfying conditions of (1) to (5) below; and

one or two selected from a cereal flour and sugars, in which

(1) a starch content is equal to or more than 75% by mass,

(2) equal to or more than 3% by mass and equal to or less than 45% by mass of molecular weight-reduced starch of starch having an amylose content of equal to or more than 5% by mass is contained, where the molecular weight-reduced starch has a peak molecular weight of equal to or more than 3×10³ and equal to or less than 5×10⁴,

(3) a degree of swelling in cold water at 25° C. is equal to or more than 5 and equal to or less than 20,

(4) a content under a sieve having a mesh size of 0.25 mm is equal to or more than 80% by mass and equal to or less than 100% by mass, and

(5) a content on a sieve having a mesh size of 0.5 mm is equal to or less than 10% by mass.

According to the present invention, there is provided a sponge cake including: a component (A) satisfying conditions of (1) to (5) below; and a powder raw material other than the component (A).

(1) A starch content is equal to or more than 75% by mass;

(2) equal to or more than 3% by mass and equal to or less than 45% by mass of molecular weight-reduced starch of starch having an amylose content of equal to or more than 5% by mass is contained, where the molecular weight-reduced starch has a peak molecular weight of equal to or more than 3×10³ and equal to or less than 5×10⁴;

(3) a degree of swelling in cold water at 25° C. is equal to or more than 5 and equal to or less than 20;

(4) a content under a sieve having a mesh size of 0.25 mm is equal to or more than 80% by mass and equal to or less than 100% by mass; and

(5) a content on a sieve having a mesh size of 0.5 mm is equal to or less than 10% by mass

According to the present invention, there is provided a method for producing a sponge cake, including:

a step of mixing a component (A) satisfying conditions of (1) to (5) below and a powder raw material other than the component (A) to obtain a dough; and a step of baking the dough.

(1) A starch content is equal to or more than 75% by mass;

(2) equal to or more than 3% by mass and equal to or less than 45% by mass of molecular weight-reduced starch of starch having an amylose content of equal to or more than 5% by mass is contained, where the molecular weight-reduced starch has a peak molecular weight of equal to or more than 3×10³ and equal to or less than 5×10⁴; (3) a degree of swelling in cold water at 25° C. is equal to or more than 5 and equal to or less than 20;

(4) a content under a sieve having a mesh size of 0.25 mm is equal to or more than 80% by mass and equal to or less than 100% by mass; and

(5) a content on a sieve having a mesh size of 0.5 mm is equal to or less than 10% by mass.

In addition, according to the present invention, there is provided a method for producing a decoration cake, including:

a step of preparing the sponge cake according to the present invention described above; and

a step of coating the sponge cake.

According to the present invention, there is provided a method for suppressing dryness of a sponge cake, including:

incorporating a component (A) satisfying conditions of (1) to (5) below into a dough of the sponge cake.

(1) A starch content is equal to or more than 75% by mass;

(2) equal to or more than 3% by mass and equal to or less than 45% by mass of molecular weight-reduced starch of starch having an amylose content of equal to or more than 5% by mass is contained, where the molecular weight-reduced starch has a peak molecular weight of equal to or more than 3×10³ and equal to or less than 5×10⁴;

(3) a degree of swelling in cold water at 25° C. is equal to or more than 5 and equal to or less than 20;

(4) a content under a sieve having a mesh size of 0.25 mm is equal to or more than 80% by mass and equal to or less than 100% by mass; and

(5) a content on a sieve having a mesh size of 0.5 mm is equal to or less than 10% by mass.

According to the present invention, there is provided a method for improving, in a decoration cake in which a sponge cake is coated with a whipped cream, a balance of meltability in mouth between the cream and the sponge cake, the method including:

incorporating a component (A) satisfying conditions of (1) to (5) below into a dough of the sponge cake.

(1) A starch content is equal to or more than 75% by mass;

(2) equal to or more than 3% by mass and equal to or less than 45% by mass of molecular weight-reduced starch of starch having an amylose content of equal to or more than 5% by mass is contained, where the molecular weight-reduced starch has a peak molecular weight of equal to or more than 3×10³ and equal to or less than 5×10⁴;

(3) a degree of swelling in cold water at 25° C. is equal to or more than 5 and equal to or less than 20;

(4) a content under a sieve having a mesh size of 0.25 mm is equal to or more than 80% by mass and equal to or less than 100% by mass; and

(5) a content on a sieve having a mesh size of 0.5 mm is equal to or less than 10% by mass.

A predetermined combination of each of these configurations, or a case obtained by changing the expression of the present invention among a method, a device, and the like is also effective as an aspect of the present invention.

For example, the present invention also includes the use of the improver for a sponge cake according to the present invention for a mixed flour for a sponge cake, a dough for a sponge cake, or a method for producing a sponge cake.

In addition, the present invention also includes the use of the mixed flour for a sponge cake or a dough for a sponge cake for a sponge cake or a method for producing the same.

### Advantageous Effects of Invention

According to the present invention, it is possible to provide a sponge cake which has excellent meltability in mouth even after storage and suppressed dryness. In addition, when the sponge cake is coated with a whipped cream, it is possible to obtain a decoration cake having an excellent balance of the meltability in mouth between the cream and the sponge cake.

### DESCRIPTION OF EMBODIMENTS

Hereinafter, embodiments of the present invention will be described with reference to specific examples of each component. Each component can be used alone or two or more kinds thereof can be used in combination.

(Improver for sponge cake)

In the present embodiment, an improver for a sponge cake contains a component (A) satisfying conditions of (1) to (5) below, as an active ingredient.

(1) A starch content is equal to or more than 75% by mass

(2) Equal to or more than 3% by mass and equal to or less than 45% by mass of molecular weight-reduced starch of starch having an amylose content of equal to or more than 5% by mass is contained, where the molecular weight-reduced starch has a peak molecular weight of equal to or more than 3×10³ and equal to or less than 5×10⁴

(3) A degree of swelling in cold water at 25° C. is equal to or more than 5 and equal to or less than 20

(4) A content under a sieve having a mesh size of 0.25 mm is equal to or more than 80% by mass and equal to or less than 100% by mass

(5) A content on a sieve having a mesh size of 0.5 mm is equal to or less than 10% by mass

Here, the sponge cake refers to a baked confectionery having good meltability in mouth, and characterized by baking a dough that uses an egg, a sugar, and a wheat flour, uses foaming properties of the egg, and has a low specific gravity. The dough having a low specific gravity referred to here is a dough before baking having a specific gravity of equal to or more than 0.3 and equal to or less than 0.6. The sponge cake according to the present invention also includes a chiffon cake and a roll cake.

A method for measuring the specific gravity of the dough is not limited and may be a generally used method. For example, the specific gravity can be calculated by leveling off the dough in a plastic cup or the like having a capacity of 100 mL, which has been weighed in advance, and measuring the mass.

Hereinafter, the component (A) will be described in more detail.

(Component (A))

Specifically, the component (A) is a powder containing starch as a main component.

Regarding the condition of (1), the component (A) contains the starch in an amount of equal to or more than 75% by mass, preferably equal to or more than 80% by mass, and still more preferably equal to or more than 85% by mass, from a viewpoint of improving the meltability in mouth of the sponge cake after storage.

Also, an upper limit of the starch content in the component (A) is not limited and is equal to or less than 100% by mass, or may also be equal to or less than 99.5% by mass, equal to or less than 99% by mass, and the like, according to properties of the sponge cake.

Regarding the condition of (2), the component (A) contains, as the starch, a molecular weight-reduced starch which uses starch having an amylose content of equal to or more than 5% by mass, as a raw material in a specific ratio, and a molecular weight-reduced starch having a specific size is used. That is, the starch in the component (A) contains equal to or more than 3% by mass and equal to or less than 45% by mass of the molecular weight-reduced starch which uses the starch having the amylose content of equal to or more than 5% by mass as a raw material in the component (A), and the peak molecular weight of the molecular weight-reduced starch is equal to or more than 3×10³ and equal to or less than 5×10⁴.

The molecular weight-reduced starch has the peak molecular weight of equal to or more than 3×10³, and preferably equal to or more than 8×10³, from the viewpoint of suppressing the dryness of the sponge cake after storage. Also, from the viewpoint of improving the meltability in mouth of the sponge cake after storage, the molecular weight-reduced starch has the peak molecular weight of equal to or less than 5×10⁴, preferably equal to or less than 3×10⁴, and still more preferably equal to or less than 1.5×10⁴. A method for measuring the peak molecular weight of the molecular weight-reduced starch will be described in a section of Examples.

From a viewpoint of excellent production stability, the molecular weight-reduced starch is preferably one or more selected from the group consisting of acid-treated starch, oxidation-treated starch, and enzyme-treated starch, and more preferably the acid-treated starch.

A condition of an acid treatment when obtaining the acid-treated starch is not limited, and a treatment can be performed as follows, for example.

First, starch having the amylose content of equal to or more than 5% by mass and water which are raw materials are added to a reaction device, and then acid is further added thereto. Alternatively, acid water, in which an inorganic acid is previously dissolved in water, and the starch as a raw material are added to the reaction device. From a viewpoint of more stably performing the acid treatment, it is desirable that a total amount of the starch in the reaction is in a state of being uniformly dispersed in an aqueous phase or in a slurry state. For the purpose, a concentration of the starch slurry in the acid treatment is adjusted to be in a range, for example, equal to or more than 10% by mass and equal to or less than 50% by mass, and preferably equal to or more than 20% by mass and equal to or less than 40% by mass. When the slurry concentration is too high, slurry viscosity may increase, and it may be difficult to stir the slurry uniformly, in some cases.

Specific examples of the acid used for the acid treatment include inorganic acids such as hydrochloric acid, sulfuric acid, and nitric acid, which can be used regardless of a kind, purity, and the like.

In a condition of the acid treatment reaction, for example, a concentration of the inorganic acid during the acid treatment is preferably equal to or more than 0.05 Normality (N) and equal to or less than 4 N, more preferably equal to or more than 0.1 N and equal to or less than 4 N, and still more preferably equal to or more than 0.2 N and equal to or less than 3 N, from a viewpoint of stably obtaining the acid-treated starch. In addition, from the same viewpoint, a reaction temperature is preferably equal to or higher than 30° C. and equal to or lower than 70° C., more preferably equal to or higher than 35° C. and equal to or lower than 70° C., and still more preferably equal to or higher than 35° C. and equal to or lower than 65° C. From the same viewpoint, a reaction time is preferably equal to or longer than 0.5 hours and equal to or shorter than 120 hours, more preferably equal to or longer than 1 hour and equal to or shorter than 72 hours, and still more preferably equal to or longer than 1 hour and equal to or shorter than 48 hours.

A content of the molecular weight-reduced starch in the component (A) is equal to or more than 3% by mass, preferably equal to or more than 8% by mass, and still more preferably equal to or more than 13% by mass, from the viewpoints of improving the meltability in mouth and suppressing dryness of the sponge cake after storage, and when the sponge cake is coated with a whipped cream, from the viewpoint of improving the balance of the meltability in mouth between the cream and the sponge cake.

On the other hand, an upper limit of the content of the molecular weight-reduced starch in the component (A) is equal to or less than 45% by mass, preferably equal to or less than 35% by mass, and still more preferably equal to or less than 25% by mass, from the same viewpoint.

In addition, the amylose content in the raw material starch of the molecular weight-reduced starch is equal to or more than 5% by mass, and from the viewpoints of improving the meltability in mouth and suppressing dryness of the sponge cake after storage, preferably equal to or more than 12% by mass, more preferably equal to or more than 22% by mass, still more preferably equal to or more than 40% by mass, still further preferably equal to or more than 45% by mass, even further preferably equal to or more than 55% by mass, and even more preferably equal to or more than 65% by mass. An upper limit of the amylose content in the raw material starch of the molecular weight-reduced starch is not limited, and is equal to or less than 100% by mass, preferably equal to or less than 90% by mass, and more preferably equal to or less than 80% by mass.

As the starch which is the raw material of the molecular weight-reduced starch and has the amylose content of equal to or more than 5% by mass, one or more selected from the group consisting of high amylose corn starch, corn starch, tapioca starch, sweet potato starch, potato starch, wheat starch, high amylose wheat starch, rice starch, and processed starch obtained by processing these raw materials chemically, physically, or enzymatically can be used. From the viewpoint of suppressing the dryness of the sponge cake after storage, it is preferable to use one or more selected from high amylose corn starch, corn starch, and tapioca starch. In addition, from the viewpoints of improving the meltability in mouth and suppressing dryness of the sponge cake after storage, the starch having the amylose content of equal to or more than 5% by mass is preferably a high amylose corn starch. The high amylose corn starch having the amylose content of equal to or more than 40% by mass is available. The starch having the amylose content of equal to or more than 5% by mass is more preferably corn starch having the amylose content of equal to or more than 40% by mass.

Also, the component (A) has a configuration in which the degree of swelling in cold water satisfies the specific condition of (3) and a particle size satisfies the specific conditions of (4) and (5).

First, regarding the condition of (3), from the viewpoint of suppressing the dryness of the sponge cake after storage, the degree of swelling in cold water of the component (A) is equal to or more than 5, preferably equal to or more than 6, and still more preferably equal to or more than 6.5.

In addition, from the viewpoint of improving the meltability in mouth of the sponge cake after storage and when the sponge cake is coated with a whipped cream, from the viewpoint of improving the balance of the meltability in mouth between the cream and the sponge cake, the component (A) has the degree of swelling in cold water of equal to or less than 20, preferably equal to or less than 17, still more preferably equal to or less than 15, and still further preferably equal to or less than 10.0.

Here, a method for measuring the degree of swelling in cold water of the component (A) will be described in a section of Examples.

Next, the particle size for the component (A) will be described.

Regarding the condition of (4), a content of particles under a sieve having a mesh size of 0.25 mm is equal to or more than 80% by mass, preferably equal to or more than 85% by mass, still more preferably equal to or more than 90% by mass, and even more preferably equal to or more than 95% by mass with respect to the entirety of the component (A), from the viewpoints of improving the meltability in mouth and suppressing dryness of the sponge cake after storage, and when the sponge cake is coated with a whipped cream, from the viewpoint of improving the balance of the meltability in mouth between the cream and the sponge cake. Even further preferably, in the component (A), the content of the particles under the sieve having a mesh size of 0.25 mm is 100% by mass.

In addition, an upper limit of the content of particles under a sieve having a mesh size of 0.25 mm is not limited and is equal to or less than 100% by mass.

In addition, regarding the condition of (5), the content of particles on a sieve having a mesh size of 0.5 mm is equal to or less than 10% by mass, preferably equal to or less than 5% by mass, still more preferably equal to or less than 3% by mass, even more preferably equal to or less than 1% by mass, and even further preferably 0% by mass, with respect to the entirety of the component (A), from the viewpoint of suppressing the dryness of the sponge cake after storage.

In addition, a lower limit of the content of particles of component (A) on a sieve having a mesh size of 0.5 mm is not limited and is equal to or more than 0% by mass.

In the component (A), the content of particles under a sieve having a mesh size of 0.25 mm and on a sieve having a mesh size of 0.075 mm is preferably equal to or more than 30% by mass, still more preferably equal to or more than 50% by mass, even more preferably equal to or more than 70% by mass, and even further preferably equal to or more than 80% by mass, with respect to the entirety of the component (A), from the viewpoint of suppressing the dryness of the sponge cake after storage. From the same viewpoint, the content of particles under a sieve having a mesh size of 0.25 mm and on a sieve having a mesh size of 0.075 mm is, for example, equal to or less than 100% by mass, preferably equal to or less than 95% by mass, and still more preferably equal to or less than 90% by mass, with respect to the entirety of the component (A).

On the other hand, from the viewpoints of improving the meltability in mouth and suppressing dryness of the sponge cake after storage, and when the sponge cake is coated with a whipped cream, from the viewpoint of improving the balance of the meltability in mouth between the cream and the sponge cake, a content of particles under a sieve having a mesh size of 0.075 mm in the component (A) is preferably equal to or more than 50% by mass, still more preferably equal to or more than 70% by mass, even more preferably equal to or more than 80% by mass, and even further preferably equal to or more than 90% by mass, with respect to the entirety of the component (A), and even further preferably, in the component (A), the content of particles under the sieve having a mesh size of 0.075 mm is 100% by mass. From the same viewpoint, an upper limit of the content of particles under a sieve having a mesh size of 0.075 mm is not limited, and is equal to or less than 100% by mass with respect to the entirety of the component (A).

In addition, from the viewpoints of improving the meltability in mouth and suppressing dryness of the sponge cake after storage and when the sponge cake is coated with a whipped cream, from the viewpoint of improving the balance of the meltability in mouth between the cream and the sponge cake, in the component (A), a content of particles under a sieve having a mesh size of 0.075 mm and on a sieve having a mesh size of 0.038 mm is preferably equal to or more than 40% by mass, still more preferably equal to or more than 50% by mass, even more preferably equal to or more than 60% by mass, and even further preferably equal to or more than 65% by mass with respect to the entirety of the component (A). From the same viewpoint, the content of particles under a sieve having a mesh size of 0.075 mm and on a 0.038 mm sieve is equal to or less than 100% by mass, still more preferably equal to or less than 95% by mass, and even more preferably equal to or less than 90% by mass, with respect to the entirety of the component (A).

In the present embodiment, the component (A) contains starch other than the molecular weight-reduced starch. Various starch can be used as a starch component other than the molecular weight-reduced starch in the component (A). Specifically, starch generally available on the market can be selected depending on use. For example, in a case of starch for foods, regardless of a kind, one or more kinds of starch such as corn starch, potato starch, tapioca starch, and wheat starch; processed starch obtained by processing these starch chemically, physically, or enzymatically; and the like can be appropriately selected. Preferably, one or more starch selected from the group consisting of the corn starch, the wheat starch, the potato starch, the tapioca starch, and crosslinked starch thereof may be contained.

In addition, a component other than the starch can be blended with the component (A) in the present embodiment.

Specific examples of the component other than the starch include insoluble salt such as a pigment, calcium carbonate, and calcium sulfate. It is preferable to blend the insoluble salt, and it is more preferable that a blending amount of the insoluble salt is equal to or more than 0.1% by mass and equal to or less than 2% by mass.

Next, a method for producing the component (A) will be described. The method for producing the component (A) includes, for example, the following steps.

(Step of preparing molecular weight-reduced starch) A step of reducing the molecular weight of the starch having the amylose content of equal to or more than 5% by mass to obtain the molecular weight-reduced starch having a peak molecular weight of equal to or more than 3×10³ and equal to or less than 5×10⁴.

(Granulation step) A step of granulating, by heat gelatinization, the raw material in which equal to or more than 3% by mass and equal to or less than 45% by mass of the molecular weight-reduced starch is contained, and the total amount of molecular weight-reduced starch and starch other than the molecular weight-reduced starch is equal to or more than 75% by mass.

The step of preparing the molecular weight-reduced starch is a step of decomposing the starch having the amylose content of equal to or more than 5% by mass into the molecular weight-reduced starch. The decomposition referred to here refers to decomposition accompanied by molecular weight reduction of starch, and examples of a typical decomposition methods include decomposition by an acid treatment, an oxidation treatment, and an enzyme treatment. Among the treatments, the acid treatment is preferable from the viewpoints of a decomposition rate, costs, and reproducibility of a decomposition reaction.

Further, in the granulation step, a general method used for granulating starch can be used, and it is preferable to use a general method used for heat gelatinization of starch, in terms of achieving a predetermined degree of swelling in cold water. Specifically, a method using a machine such as a drum dryer, a jet cooker, an extruder, or a spray dryer is known. However, in the present embodiment, from the viewpoint of more reliably obtaining the component (A) in which the degree of swelling in cold water satisfies the above-mentioned specific condition, the heat gelatinization with the extruder or the drum dryer is preferable, and the extruder is more preferable.

In a case of an extruder treatment, usually, water is added to a raw material containing starch to adjust the moisture content to about 10% to 60% by mass, and then heated and swelled, for example, in conditions of a barrel temperature of 30° C. to 200° C., an outlet temperature of 80° C. to 180° C., a screw rotation speed of 100 to 1,000 rpm, and a heat treatment time of 5 to 60 seconds.

In the present embodiment, for example, by the step of heat-gelatinizing the specific raw material, the component (A) in which the degree of swelling in cold water satisfies a specific condition can be obtained.

In addition, the component (A) satisfying the conditions of (4) and (5) may be obtained by, as needed, pulverizing and sieving a granulated product obtained by heat gelatinization and appropriately adjusting a size thereof.

The component (A) obtained as described above is a starch powder containing a molecular weight-reduced starch and has a configuration satisfying the conditions of (1) to (5). Therefore, the component (A) is blended with the sponge cake to form a sponge cake, whereby it is possible to improve the meltability in mouth of the sponge cake and suppress the dryness thereof, after storage, for example, storage at a temperature of equal to or lower than 10° C. and when the sponge cake is coated with a whipped cream, it is possible to improve the balance of the meltability in mouth between the cream and the sponge cake. In addition, when using the component (A), it is possible to improve the meltability in mouth and suppress the dryness, after storage at a temperature of, for example, higher than 10° C. and equal to or lower than 50° C., preferably higher than 10° C. and equal to or lower than 35° C.

For example, in the present embodiment, a method for suppressing the dryness of the sponge cake includes incorporating the component (A) into the dough of the sponge cake.

Here, the dryness of the sponge cake specifically refers to a state in which the sponge cake is dried, hardened, and not moist. In the present embodiment, the component (A) can be used to suppress the dryness of the sponge cake whose outer surface is not coated, or used to suppress the dryness of the sponge cake whose outer surface is coated such as a decoration cake. The component (A) is preferably used to suppress the dryness of the sponge cake whose outer surface is coated, and more preferably used to suppress the dryness of the sponge cake coated with a whipped cream or chocolate.

In addition, the dryness of the sponge cake occurs preferably at a temperature of equal to or lower than 10° C., and occurs more preferably at a temperature of higher than 0° C. and equal to or lower than 10° C. In addition, the dryness of the sponge cake may occur, for example, at a temperature of higher than 10° C. and equal to or lower than 50° C., and preferably higher than 10° C. and equal to or lower than 35° C.

Further, in the present embodiment, a method for improving, in a decoration cake in which a sponge cake is coated with a whipped cream, the balance of the meltability in mouth between the cream and the sponge cake includes incorporating the component (A) into the dough of the sponge cake.

Here, improving, in a decoration cake, the balance of the meltability in mouth between the cream and the sponge cake refers to that the sponge cake does not remain in the mouth and does not disturb the whipped cream to be excellent. More specifically, when using the component (A) for the sponge cake, a melting timing in-a-mouth of the cream and the sponge cake in the decoration cake is good and the texture becomes to have a sense of unity. As a result, the balance of the meltability in mouth between the cream and the sponge cake is improved.

In the present embodiment, when blending an improver for a sponge cake containing the component (A) as an active ingredient to obtain a sponge cake, it is possible to improve the meltability in mouth of the sponge cake and suppress the dryness, and when the sponge cake is decorated with the whipped cream it is possible to improve the balance of the meltability in mouth between the cream and the sponge cake. In addition, these favorable textures or flavors can be obtained even after storage.

A content of the component (A) in the improver for a sponge cake is preferably equal to or more than 50% by mass, still more preferably equal to or more than 80% by mass, and even more preferably equal to or more than 90% by mass with respect to the entirety of the improver for a sponge cake, from the viewpoints of improving the meltability in mouth and suppressing dryness of the sponge cake after storage, and when the sponge cake is decorated with a whipped cream, from the viewpoint of improving the balance of the meltability in mouth between the cream and the sponge cake.

Also, an upper limit of the content of the component (A) in the improver for a sponge cake is not limited and is equal to or less than 100% by mass, and may also be, for example, equal to or less than 99% by mass.

In addition, the improver for the sponge cake is preferably made of the component (A).

When the improver for a sponge cake contains a component other than the component (A), specific examples of the component other than the component (A) include starch, a cereal flour, and sugars.

(Dough for sponge cake)

In the present embodiment, the dough for a sponge cake contains the component (A) and a powder raw material other than the component (A).

The powder raw material is a raw material that is blended in a powdery form in the dough for a sponge cake and is a raw material other than the component (A). Specific examples of the powder raw material include a cereal flour such as a wheat flour and a soybean flour; proteins such as gluten and soybean protein; sugars such as sugar, fructose, glucose, isomerized sugar, converted sugar, oligosaccharide, starch, dextrin, trehalose, sugar alcohol (such as maltitol, erythritol, sorbitol, xylitol, and lactitol), and powdered sweeteners such as aspartame, acesulfam potassium, advantame, sucralose, ariteme, neotheme, saccharin, and stevia extract; dietary fiber such as bran, cellulose, and indigestible dextrin; leavening agent such as a baking powder; milks such as a skim milk powder, a full-fat milk powder, and a cheese powder; eggs such as egg white powder and whole egg powder; thickening polysaccharides such as guar gum and alginate; an emulsifier; flavoring materials such as a cocoa powder and a matcha powder; and a flavor and a flavor improver. From the viewpoint of obtaining the sponge cake having excellent production stability, the powder raw material preferably contains the cereal flour, and still more preferably contains the wheat flour.

The content of component (A) with respect to the total content of the powder raw material and the component (A) in the dough for a sponge cake is preferably equal to or more than 0.3% by mass, still more preferably equal to or more than 0.5% by mass, even more preferably equal to or more than 1.0% by mass, and even further preferably equal to or more than 2.0% by mass, from the viewpoint of improving the melt in-a-mouth and suppressing the dryness of the sponge cake after storage, and when the sponge cake is coated with a whipped cream, from the viewpoint of improving the balance of the meltability in mouth between the cream and the sponge cake.

Also, from the viewpoint of improving the meltability in mouth of the sponge cake after storage, the content of the component (A) with respect to the total content of the powder raw material and the component (A) in the dough for a sponge cake is preferably equal to or less than 25% by mass, more preferably equal to or less than 20% by mass, still more preferably equal to or less than 16% by mass, still further preferably equal to or less than 12% by mass, even more preferably equal to or less than 10% by mass, particularly preferably equal to or less than 8% by mass, and even further preferably equal to or less than 6% by mass.

Also, in a case of a roll cake, from the viewpoint of suppressing the dryness of a sponge cake portion and improving the meltability in mouth, and from the viewpoint of improving the balance of meltability in mouth between the whipped cream and the sponge cake when decorated with the whipped cream, the content of the component (A) with respect to the total content of the powder raw material and the component (A) in the dough is preferably equal to or more than 0.3% by mass and equal to or less than 25% by mass, more preferably equal to or more than 0.5% by mass and equal to or less than 20% by mass, still more preferably equal to or more than 1.0% by mass and equal to or less than 16% by mass, and even further preferably equal to or more than 2.0% by mass and equal to or less than 16% by mass.

Here, in the present specification, the “total content of the powder raw material and the component (A)” is the total of the component (A) and the powder raw material other than the component (A).

The content of component (A) with respect to the total content of the cereal flour and the component (A) in the dough for a sponge cake is preferably equal to or more than 1% by mass, still more preferably equal to or more than 2% by mass, and even more preferably equal to or more than 4% by mass, from the viewpoint of improving the melt in-a-mouth and suppressing the dryness of the sponge cake after storage, and when the sponge cake is coated with a whipped cream, from the viewpoint of improving the balance of the meltability in mouth between the cream and the sponge cake.

Also, from the viewpoint of improving the meltability in mouth of the sponge cake after storage, the content of the component (A) with respect to the total content of the cereal flour and the component (A) in the dough for a sponge cake is preferably equal to or less than 40% by mass, more preferably equal to or less than 33% by mass, still more preferably equal to or less than 27% by mass, even further preferably equal to or less than 15% by mass, and even more preferably equal to or less than 12% by mass.

Also, in a case of the roll cake, from the viewpoint of suppressing the dryness of a sponge cake portion and improving the meltability in mouth, and from the viewpoint of improving the balance of meltability in mouth between the whipped cream and the sponge cake when decorated with the whipped cream, the content of the component (A) with respect to the total content of the cereal flour and the component (A) in the dough is preferably equal to or more than 1% by mass and equal to or less than 40% by mass, more preferably equal to or more than 2% by mass and equal to or less than 33% by mass, and still more preferably equal to or more than 4% by mass and equal to or less than 27% by mass.

Also, the dough for a sponge cake may contain a component other than the component (A) and the powder raw material described above. Specific examples of the other component include an egg liquid such as whole eggs, egg whites, and egg yolks; edible oils and fats such as liquid oils and solid fats; liquids such as water, milk, soymilk, fruit juice, honey, black honey, and maple syrup; nuts; and dried fruits.

(Mixed flour for sponge cake)

In the present embodiment, the mixed flour for a sponge cake contains the component (A) and a part or all of the powder raw material. As specific examples of the powder raw material, those exemplified as the cereal flour and the sugars to be blended in the dough for a sponge cake can be used, respectively.

More specifically, in the present embodiment, a mixed flour for a sponge cake contains the component (A) and one or two selected from the group consisting of a cereal flour and sugars. As specific examples of the cereal flour and the sugars, those exemplified as the cereal flour and the sugars to be blended in the dough for a sponge cake can be used, respectively.

The content of component (A) in the mixed flour for a sponge cake is preferably equal to or more than 0.3% by mass, still more preferably equal to or more than 0.5% by mass, even more preferably equal to or more than 1.0% by mass, and even further preferably equal to or more than 2.0% by mass, with respect to the entirety of the mixed flour for a sponge cake, from the viewpoint of improving the melt in-a-mouth and suppressing the dryness of the sponge cake after storage, and when the sponge cake is coated with a whipped cream, from the viewpoint of improving the balance of the meltability in mouth between the cream and the sponge cake.

Also, from the viewpoint of improving the meltability in mouth of the sponge cake after storage, the content of the component (A) in the mixed flour for a sponge cake is preferably equal to or less than 50% by mass, more preferably equal to or less than 35% by mass, still more preferably equal to or less than 20% by mass, still further preferably equal to or less than 12% by mass, even more preferably equal to or less than 10% by mass, particularly preferably equal to or less than 8% by mass, and even further preferably equal to or less than 6% by mass, with respect to the entirety of the mixed flour for a sponge cake.

Also, in a case of the roll cake, from the viewpoint of suppressing the dryness of a sponge cake portion and improving the meltability in mouth, and from the viewpoint of improving the balance of meltability in mouth between the whipped cream and the sponge cake when decorated with the whipped cream, the content of the component (A) in the mixed flour for a sponge cake is preferably equal to or more than 0.3% by mass and equal to or less than 50% by mass, more preferably equal to or more than 0.5% by mass and equal to or less than 35% by mass, and still more preferably equal to or more than 1.0% by mass and equal to or less than 20% by mass, with respect to the entirety of the mixed flour for a sponge cake.

(Sponge cake)

In the present embodiment, a sponge cake contains the component (A) and a powder raw material other than the component (A). As the powder raw material, those exemplified as the powder raw material to be blended in the dough for a sponge cake can be used.

The content of component (A) with respect to the total content of the powder raw material and the component (A) in the sponge cake is preferably equal to or more than 0.3% by mass, still more preferably equal to or more than 0.5% by mass, even more preferably equal to or more than 1.0% by mass, and even further preferably equal to or more than 2.0% by mass, from the viewpoint of improving the melt in-a-mouth and suppressing the dryness of the sponge cake after storage, and when the sponge cake is coated with a whipped cream, from the viewpoint of improving the balance of the meltability in mouth between the cream and the sponge cake.

Also, from the viewpoint of improving the meltability in mouth of the sponge cake after storage, the content of the component (A) with respect to the total content of the powder raw material and the component (A) in the sponge cake is preferably equal to or less than 25% by mass, more preferably equal to or less than 20% by mass, still more preferably equal to or less than 16% by mass, still further preferably equal to or less than 12% by mass, even more preferably equal to or less than 10% by mass, particularly preferably equal to or less than 8% by mass, and even further preferably equal to or less than 6% by mass.

Also, in a case of a roll cake, from the viewpoint of suppressing the dryness of a sponge cake portion and improving the meltability in mouth, and from the viewpoint of improving the balance of meltability in mouth between the whipped cream and the sponge cake when decorated with the whipped cream, the content of the component (A) with respect to the total content of the powder raw material and the component (A) in the sponge cake is preferably equal to or more than 0.3% by mass and equal to or less than 25% by mass, more preferably equal to or more than 0.5% by mass and equal to or less than 20% by mass, still more preferably equal to or more than 1.0% by mass and equal to or less than 16% by mass, and even further preferably equal to or more than 2.0% by mass and equal to or less than 16% by mass.

In addition, the sponge cake may contain a component other than the component (A) and the powder raw material described above, and specific examples of the other component include the components described above for dough for a sponge cake.

In the present embodiment, the sponge cake can be obtained by, for example, a production method including a step of mixing the component (A) and the powder raw material other than the component (A) to obtain a dough; and a step of baking the dough.

Further, in the present embodiment, the decoration cake can be obtained by a production method including, for example, a step of preparing the sponge cake according to the present embodiment; and a step of coating the sponge cake. In addition, the method for producing the decoration cake may include a step of storing the sponge cake at a temperature of equal to or lower than 10° C., and still more preferably at a temperature of higher than 0° C. and equal to or lower than 10° C., after the step of coating. In addition, the method for producing the decoration cake may include a step of storing the sponge cake at a temperature of equal to or lower than 50° C., and still more preferably at a temperature of higher than 10° C. and equal to or lower than 35° C., after the step of coating.

Specific examples of the coating include cream coatings using a whipped cream, a butter cream, and the like, and chocolate coatings, and are preferably one or two selected from the whipped cream and the chocolate coating.

The coating may be applied to a part of a side surface or an upper surface of the decoration cake, or may be applied to the entire cake. From the viewpoint of improving the meltability in mouth and suppressing the dryness of the sponge cake after storage, and when the sponge cake is coated with a whipped cream, from the viewpoint of improving the balance of the meltability in mouth between the cream and the sponge cake, it is preferable to perform the coating on entirety of the side surface and the upper surface of the decoration cake. Here, an aspect of the coating according to the present embodiment also includes a case in which an inner side of the sponge cake is coated with the whipped cream, as the roll cake, and a case in which the sponge cake wraps the whipped cream.

In addition, a thickness of the coating can be adjusted as appropriate, depending on the kinds of the coatings. From the viewpoints of improving the meltability in mouth and suppressing the dryness of the sponge cake after storage, and when the sponge cake is coated with a whipped cream, from the viewpoint of improving the balance of the meltability in mouth between the cream and the sponge cake, the thickness is preferably equal to or more than 1 mm, and also may be, for example, equal to or less than 10 mm.

Since the sponge cake obtained in the present embodiment contains the component (A) as an active ingredient, it is possible to obtain the sponge cake which has an excellent meltability in mouth even after storage and suppressed dryness.

Moreover, since the decoration cake obtained by coating the sponge cake in the present embodiment also contains the component (A) as an active ingredient in the sponge cake portion, it is possible to obtain the sponge cake which has excellent meltability in mouth even after storage and suppressed dryness, similarly. In addition, the decoration cake coated with the whipped cream can improve the balance of the meltability in mouth between the cream and the sponge cake.

Further, according to the present embodiment, for example, it is possible to improve the meltability in mouth and to suppress the dryness of the sponge cake after storage at 4° C. for equal to or longer than 1 day or equal to or longer than 3 days.

Further, according to the present embodiment, for example, it is possible to improve the meltability in mouth and to suppress the dryness of the sponge cake after storage at a normal temperature (20° C.), for example, for equal to or longer than 1 day or equal to or longer than 5 days.

### EXAMPLES

Examples of the present invention will be shown below, but the gist of the present invention is not limited thereto.

(Raw material)

The following raw materials were mainly used.

(Starch)

Corn starch: “Corn starch Y”, manufactured by J-OIL MILLS, INC.

High amylose corn starch: “HS-7”, manufactured by J-OIL MILLS, INC., amylose content of 70% by mass

(Oil and fat product)

Oil and fat product 1 (processed oil and fat): “Splendor L”, manufactured by J-OIL MILLS, INC.

Oil and fat product 2 (processed oil and fat): “Splendor HG”, manufactured by J-OIL MILLS, INC.

Oil and fat product 3: “Cake Short Ace”, manufactured by J-OIL MILLS, INC.

Oil and fat product 4: Rapeseed oil, manufactured by J-OIL MILLS, INC.

(Others)

Soft flour (powder raw material): “Flour”, manufactured by Nisshin Foods Inc.

Baking powder (powder raw material): “F-up”, manufactured by Aikoku Co., Ltd.

Sugar (powder raw material): White sugar, manufactured by Mitsui Sugar Co., Ltd.

Fresh cream: “Tokusen Hokkaido Jun-nama Cream 35 (Specialty Hokkaido Pure Fresh Cream 35)”, manufactured by Takanashi Milk Products Co., Ltd.

Chocolate for coating: Cacao Barry Pate A Glacer Brun Chocolate Coating, manufactured by Nichifutsu Shoji Co., Ltd.

Skim milk powder (powder raw material): Morinaga skim milk, Morinaga Milk Industry Co., Ltd.

Honey: “Funwari Renge Hachimitsu (Soft Astragalus honey)” manufactured by Kato Bihouen Honpo Co., Ltd.

Liquid sugar: “High Sweet Deluxe” manufactured by Mitsubishi-Chemical Foods Corporation

### (Production Example 1) Production of Starch Powder

In the present example, acid-treated starch was used as the molecular weight-reduced starch to obtain the starch powder.

(Method for producing acid-treated high-amylose corn starch)

High amylose corn starch was suspended in water to prepare 35.6% (w/w) slurry, and was heated to 50° C. A reaction was started by adding an aqueous hydrochloric acid solution prepared to be 4.25 N in an amount of 1/9 times in terms of a mass ratio of the slurry while stirring. After reacting for 16 hours, it was neutralized with 3% NaOH, washed with water, dehydrated, and dried to obtain acid-treated high-amylose corn starch.

The peak molecular weight of the obtained acid-treated high-amylose corn starch was measured by a method below, as a result, the peak molecular weight was 1.2×10⁴.

(Method for measuring peak molecular weight)

The peak molecular weight was measured using an HPLC unit manufactured by Tosoh Corporation (Pump DP-8020, RI detector RS-8021, and Degassing device SD-8022).

(1) A sample was pulverized, and a fraction under a sieve having a mesh size of 0.15 mm was collected using a sieve of JIS-Z8801-1 standard. This collected fraction was suspended in a mobile phase so as to be 1 mg/mL, and the suspension was heated at 100° C. for 3 minutes to completely dissolve. Filtration was performed using a 0.45 μm filtration filter (manufactured by ADVANTEC, DISMIC-25HP PTFE 0.45 μm), and a filtrate was used as an analytical sample.

(2) A molecular weight was measured under the following analysis conditions.

Column: Two columns of TSKgel α-M (7.8 mmφ, 30 cm) (made by Tosoh Corporation)

Flow rate: 0.5 mL/min

Mobile phase: 5 mM NaNO₃-containing dimethyl sulfoxide solution at 90% (v/v)

Column temperature: 40° C.

Analytical volume: 0.2 mL

(3) The detector data was collected by software (multi-station GPC-8020 model II data collection ver 5.70, manufactured by Tosoh Corporation), and the molecular weight peak was calculated.

For a calibration curve, Pullulan with a known molecular weight (Shodex Standard P-82, manufactured by Showa Denko KK) was used.

(Method for producing starch powder)

79% by mass of β-starch (corn starch), 20% by mass of acid-treated high-amylose corn starch obtained by the above method, and 1% by mass of calcium carbonate were mixed in a bag to be sufficiently uniform. A mixture was heat-treated under pressure using a twin-screw extruder (KEI-45 manufactured by Kowa Industry Co., Ltd.). Processing conditions are as follows.

Raw material supply: 450 g/min

Water addition: 17% by mass

Barrel temperature: 50° C., 70° C., and 100° C. from the raw material inlet to the outlet

Outlet temperature: 100° C. to 110° C.

Screw rotation speed of 250 rpm

A heat-gelatinized product obtained by the extruder treatment in this manner was dried at 110° C. to adjust the moisture content to about 10% by mass.

Next, the dried heat-gelatinized product was pulverized with a desktop cutter pulverizer and then sieved using a sieve of JIS-Z8801-1 standard. The sieved heat-gelatinized product was mixed at the blending ratios shown in Table 1 to prepare the starch powders 1 to 4. In addition, the degree of swelling in cold water of each starch powder was measured by the method to be described later.

(Method for measuring degree of swelling in cold water)

(1) A sample was dried by heating at 125° C. using a moisture meter (model number MX-50, manufactured by Kensei Kogyo Co., Ltd.) to measure the moisture, and the mass of dry matter was calculated from a moisture value obtained.

(2) 1 g of the sample in terms of the mass of dry matter was in a state of being dispersed in 50 mL of water at 25° C., gently stirred in a constant temperature bath at 25° C. for 30 minutes, and then centrifuged at 3000 rpm for 10 minutes (Centrifuge: Hitachi desktop centrifuge CT6E type, manufactured by Hitachi Koki Co., Ltd.; Rotor: T4SS type swing rotor; and Adapter: 50TC×2S adapter), and separated into a sediment layer and a supernatant layer.

(3) The supernatant layer was removed, the mass of the sediment layer was measured, and this mass was set as B (g).

(4) The mass when the sediment layer was dried and solidified (105° C., constant weight) was set as C (g).

(5) A value obtained by dividing B by C was set as the degree of swelling in cold water.

### Experimental Examples 1 to 3

In this example, a sponge cake and a decoration cake were produced using the improver for a sponge cake formed of the starch powders 1 to 4 obtained in Production Example 1 and evaluated. In Experimental Example 1, Examples 1-1 to 1-3 and Comparative Example 1-1 were evaluated based on Control Example 1. In Experimental Example 2, Examples 2-1 to 2-3 were evaluated based on Control Example 2. Moreover, in Experimental Example 3, Example 3-1 and Comparative Example 3 were evaluated based on Control Example 3.

The blending and evaluation results of each example in Experimental Examples 1 to 3 are shown in Tables 2 to 4, respectively. In Tables 2 to 4 and Tables 5 to 7 to be described later, all units of (Starch powder/(Powder raw material+Starch powder)) and (Starch powder/(Cereal flour+Starch powder)) are % by mass.

Further, in Tables 2 to 4, and Tables 5 to 7 to be described later, “Powder raw material+Starch powder” is the total of the starch powder and the powder raw material other than the starch powder.

(Method for producing sponge cake by all-in-mix method)

1. Among the raw materials, the soft flour, the starch powder, the sugar, and the baking powder were put in a plastic bag and mixed to prepare a mixed flour. In Control Example, the soft flour, the sugar, and the baking powder were put in a plastic bag and mixed to obtain a mixed flour.

2. Whole eggs, each of the oil and fat products, and the mixed flour obtained in 1. was placed in a bowl and mixed with a hobart mixer equipped with a whisk at medium speed so that the specific gravity was 0.40 to 0.43.

3. 280 g of the mixed dough was put into a No. 6 round mold and baked in an oven under the following conditions.

Baking conditions: Upper part 180° C./Lower part 180° C.

Baking time: 27 minutes

(Method for producing decoration cake)

For each Example, Comparative Example, and Control Example (however, excluding Example 3-1, Comparative Example 3, and Control Example 3), the fresh cream was decorated by the following method, and the fresh cream decoration cake of each example was obtained.

1. One pack of fresh cream was placed in a bowl, 8 g of white sugar was added, and the mixture was whipped at medium speed with a mixer to obtain an 80% stiff whipped cream.

2. The sponge cake of each example after baking was cut into two pieces in the horizontal direction, and the whipped cream was evenly applied to the cut one side with a palette knife to have a thickness of 2 to 3 mm.

3. The surfaces of the sponge cake coated with the cream in above 2. were overlapped with each other, and the whipped cream was evenly applied to the upper surface and the side surface with a palette knife to have a thickness of 2 to 3 mm to obtain a decoration cake.

4. The obtained decoration cake was placed in a cake paper box (dimensions: 220×220×118 mm) and stored at 4° C. for 3 days.

5. The cake was taken out of the box, divided into 8 equal parts, eaten, and evaluated.

Further, in Example 3-1, Comparative Example 3, and Control Example 3, chocolate was coated by the following method to obtain a chocolate decoration cake of each example.

(Method for producing chocolate decoration cake)

1. 200 g of chocolate was finely ground with a knife, placed in a bowl, and dissolved in hot water at 60° C. to obtain chocolate for coating.

2. The chocolate for coating was evenly applied to the entire surface of the sponge cake after baking except for the bottom surface with a palette knife to a have a thickness of 2 to 3 mm to obtain a chocolate decoration cake.

3. The obtained chocolate decoration cake was placed in a cake paper box (dimensions: 220×220×118 mm) and stored at 4° C. for 3 days.

4. The cake was taken out of the box, divided into 8 equal parts, eaten, and evaluated.

(Evaluation of decoration cake)

The decoration cake obtained in each example was stored in a refrigerator (4° C.) for 3 days. Also, the degree of dryness of the sponge cake and the meltability in mouth of the sponge cake portion in the decoration cake of each example after storage, were evaluated with respect to Control Example after storage. In addition, in a case of coating with cream, the balance of the meltability in mouth between the whipped cream and the sponge cake was evaluated together.

In Experimental Examples 1 and 2, the evaluation was performed by calculating an average value of scores of five specialized panelists. For each item, the control example after storage was given the score of 3, and the score was given in a range of scores of 1 to 5, and a score of more than 3 was set as a pass. In Experimental Examples 3 to 5, evaluation was performed by the consensus of three specialized panelists. In a case where an evaluation result was located in the middle of each evaluation, a value in the middle was set as the score. For example, in a case where the evaluation was between 4 and 5, it was evaluated as 4.5.

The evaluation criteria for each item are as follows.

(Degree of dryness of sponge cake)

Score 5: Very moist

Score 4: Moist

Score 3: Slightly dry (same as Control Example)

Score 2: Dry

Score 1: Quite dry

(Meltability in mouth of sponge cake portion)

Score 5: Very good meltability in mouth, and not sticky

Score 4: Good meltability in mouth and almost not sticky

Score 3: Not so good meltability in mouth and a little sticky (same level as Control Example)

Score 2: Not good meltability in mouth and slightly sticky

Score 1: Poor meltability in mouth, residuals in-a-mouth, and quite sticky.

(Balance of meltability in mouth between whipped cream and sponge cake)

Score 5: Very good balance of meltability in mouth between whipped cream and sponge cake

Score 4: Good balance of meltability in mouth between whipped cream and sponge cake

Score 3: Not so good balance of meltability in mouth between the whipped cream and the sponge cake (same level as Control Example)

Score 2: Poor balance of meltability in mouth between whipped cream and sponge cake

Score 1: Very poor balance of meltability in mouth between whipped cream and sponge cake

TABLE 1

| | Starch | Starch | Starch | Starch |
|---|---|---|---|---|
| Fraction (% by mass) | powder 1 | powder 2 | powder 3 | powder 4 |
| On a 500 μm sieve | 18.0 | 0.0 | 0.0 | 0.0 |
| under a 500 μm sieve | 42.0 | 0.0 | 0.0 | 0.0 |
| and on a 250 μm sieve | | | | |
| finder a 250 μm sieve | 35.0 | 84.4 | 0.0 | 0.0 |
| and on a 75 μm sieve | | | | |
| Under a 75 μm sieve | 3.7 | 11.4 | 73.1 | 0.0 |
| and on a 38 μm sieve | | | | |
| Under a 38 μm sieve | 1.3 | 4.2 | 26.9 | 100.0 |
| Total | 100.0 | 100.0 | 100.0 | 100.0 |
| Degree of swelling | 10.5 | 7.3 | 8.5 | 7.5 |
| in cold water | | | | |

TABLE 2

| | | | Compar- | | | |
|---|---|---|---|---|---|---|
| | | Control | ative | | | |
| | | Exam- | Exam- | Exam- | Exam- | Exam- |
| | | ple 1 | ple 1-1 | ple 1-1 | ple 1-2 | ple 1-3 |
| Kind of starch powder | | — | Starch | Starch | Starch | Starch |
| | | | pow- | pow- | pow- | pow- |
| | | | der 1 | der 2 | der 3 | der 4 |
| Blending Part(s) by mass | | | | | | |
| Powder | Sugar | 100 | 100 | 100 | 100 | 100 |
| raw | Soft flour | 100 | 90 | 90 | 90 | 90 |
| material | Starch powder | 0 | 10 | 10 | 10 | 10 |
| | Baking powder | 2 | 2 | 2 | 2 | 2 |
| Other raw | Oil and fat | 40.0 | 40 | 40 | 40 | 40 |
| material | product 1 | | | | | |
| | Oil and fat | 15 | 15 | 15 | 15 | 15 |
| | product 2 | | | | | |
| | Whole egg (net | 150 | 150 | 150 | 150 | 150 |
| | content) | | | | | |
| Total | | 407 | 407 | 407 | 407 | 407 |
| (Starch powder/(Powder raw | | 0 | 4.95 | 4.95 | 4.95 | 4.95 |
| material + Starch powder)) | | | | | | |
| (Starch powder/(Cereal flour + | | 0 | 10.0 | 10.0 | 10.0 | 10.0 |
| Starch powder)) | | | | | | |
| Evaluation | Degree of | 3.0 | 3.3 | 4.3 | 4.0 | 3.8 |
| score | dryness of | | | | | |
| | sponge cake | | | | | |
| | Feeling of | 3.0 | 3.0 | 4.0 | 4.4 | 3.8 |
| | meltability in | | | | | |
| | mouth of | | | | | |
| | sponge cake | | | | | |
| | portion | | | | | |
| | Balance of | 3.0 | 2.8 | 3.8 | 4.2 | 3.6 |
| | feeling of | | | | | |
| | meltability in | | | | | |
| | mouth between | | | | | |
| | whipped cream | | | | | |
| | and sponge cake | | | | | |

Regarding Experimental Example 1, from Table 2, regarding the degree of dryness of the sponge cake, all of the sponge of Example 1-1 containing the starch powder 2 having 84.4% F by mass of a content under a 250 μm sieve and on a 75 μm sieve, the sponge cake of Example 1-2 containing the starch powder 3 having 100% by mass of content of under the 75 μm sieve, and the sponge cake of Example 1-3 containing the starch powder 4 having 100% by mass of a content under the 38 μm sieve were good. Among these, the sponge cakes of Example 1-1 and Example 1-2 were excellent, and the sponge cake of Example 1-1 were further excellent.

Regarding the meltability in mouth of the sponge cake portion and the balance of the meltability in mouth between the whipped cream and the sponge cake, any of Examples 1-1 to 1-3 containing the starch powders 2 to 4, respectively, is preferable. Examples 1-1 and 1-2 containing the starch powders 2 and 3, respectively, were more preferable, and Example 1-2 containing the starch powder 3 was very preferable.

On the other hand, in Comparative Example 1, the decoration cake containing the starch powder 1 having 60% by mass of a content on the 250 μm sieve had a residuals in-a-mouth of the sponge cake, and was not so good in the meltability in mouth and balance of the meltability in mouth between the whipped cream and the sponge cake, as compared with those in each example.

TABLE 3

| | | Control | | | |
|---|---|---|---|---|---|
| | | Exam- | Exam- | Exam- | Exam- |
| | | ple 2 | ple 2-1 | ple 2-2 | ple 2-3 |
| Kind of starch powder | | — | Starch | Starch | Starch |
| | | | pow- | pow- | pow- |
| | | | der 2 | der 2 | der 2 |
| Blending Part(s) by mass | | | | | |
| Powder | Sugar | 100 | 100 | 100 | 100 |
| raw | Soft flour | 100 | 97 | 95 | 90 |
| material | Starch powder | 0 | 3 | 5 | 10 |
| | Baking powder | 2 | 2 | 2 | 2 |
| Other raw | Oil and fat | 40 | 40 | 40 | 40 |
| material | product 1 | | | | |
| | Oil and fat | 15 | 15 | 15 | 15 |
| | product 2 | | | | |
| | Whole egg (net | 150 | 150 | 150 | 150 |
| | content) | | | | |
| Total | | 407 | 407 | 407 | 407 |
| (Starch powder/(Powder raw | | 0 | 1.49 | 2.48 | 4.95 |
| material + Starch powder)) | | | | | |
| (Starch powder/(Cereal flour + | | 0 | 3.0 | 5.0 | 10.0 |
| Starch powder)) | | | | | |
| Evaluation | Degree of | 3.0 | 3.4 | 3.3 | 4.3 |
| score | dryness of | | | | |
| | sponge cake | | | | |
| | Feeling of | 3.0 | 4.0 | 3.5 | 4.0 |
| | meltability | | | | |
| | in mouth of | | | | |
| | sponge cake | | | | |
| | portion | | | | |
| | Balance of | 3.0 | 3.5 | 3.8 | 3.8 |
| | feeling of | | | | |
| | meltability | | | | |
| | in mouth | | | | |
| | between | | | | |
| | whipped | | | | |
| | cream and | | | | |
| | sponge cake | | | | |

In Experimental Example 2, from Table 3, regarding the dryness, all of Examples 2-1 to 2-3 in which (Starch powder/(Powder raw material+Starch powder)) was equal to or more than 1.49% by mass and equal to or less than 4.95% by mass were good, and Example 2-3 in which the ratio was 4.95% by mass, was the most moist and good. Regarding the meltability in mouth, all of Examples 2-1 to 2-3 in which (Starch powder/(Powder raw material+Starch powder)) was equal to or more than 1.49% by mass and equal to or less than 4.95% by mass were good in the meltability in mouth. Regarding the balance of the meltability in mouth between the whipped cream and the sponge cake, all of Examples 2-1 to 2-3 in which (Starch powder/(Powder raw material+Starch powder)) was equal to or more than 1.49% by mass and equal to or less than 4.95% by mass were good, and Examples 2-2 and 2-3 in which the ratio was equal to or more than 2.48% by mass and equal to or less than 4.95% by mass, were especially good.

In addition, regarding the dryness, all of Examples 2-1 to 2-3 in which (Starch powder/(Cereal flour+Starch powder)) was equal to or more than 3.0% by mass and equal to or less than 10.0% by mass were good, and Example 2-3 in which the ratio was 10.0% by mass, was the most moist and good. Regarding the meltability in mouth, all of Examples 2-1 to 2-3 in which (Starch powder/(Cereal flour+Starch powder)) was equal to or more than 3.0% by mass and equal to or less than 10.0% by mass were good in the meltability in mouth. Regarding the balance of the meltability in mouth between the whipped cream and the sponge cake, all of Examples 2-1 to 2-3 in which (Starch powder/(Cereal flour+Starch powder)) was equal to or more than 3.0% by mass and equal to or less than 10.0% by mass were good, and Examples 2-2 and 2-3 in which the ratio was equal to or more than 5.0% by mass and equal to or less than 10.0% by mass, were especially good.

TABLE 4

| | | | Compar- | |
|---|---|---|---|---|
| | | Control | ative | |
| | | Exam- | Exam- | Exam- |
| | | ple 3 | ple 3 | ple 3-1 |
| Kind of starch powder | | — | Starch | Starch |
| | | | pow- | pow- |
| | | | der 1 | der 2 |
| Blending Part(s) by mass | | | | |
| Powder | Sugar | 100 | 100 | 100 |
| raw | Soft flour | 100 | 90 | 90 |
| material | Starch powder | 0 | 10 | 10 |
| | Baking powder | 2 | 2 | 2 |
| Other raw | Oil and fat | 40 | 40 | 40 |
| material | product 1 | | | |
| | Oil and fat | 15 | 15 | 15 |
| | product 2 | | | |
| | Whole egg (net | 150 | 150 | 150 |
| | content) | | | |
| Total | | 407 | 407 | 407 |
| (Starch powder/(Powder raw | | 0 | 4.95 | 4.95 |
| material + Starch powder)) | | | | |
| (Starch powder/(Cereal flour + | | 0 | 10.0 | 10.0 |
| Starch powder)) | | | | |
| Evaluation | Degree of | 3.0 | 3.0 | 4.0 |
| score after | dryness of | | | |
| | sponge cake | | | |
| 3 days of | Feeling of | 3.0 | 3.0 | 4.0 |
| refrigeration | meltability | | | |
| with chocolate | in mouth of | | | |
| coating | sponge cake | | | |
| | portion | | | |

Regarding Experimental Example 3, from Table 4, even in the chocolate coating, in Example 3-1 in which the starch powder 2 was added to the sponge cake, a cake in which the dryness of the sponge cake was suppressed even when storage at 4° C. for 3 days and the meltability in mouth was good was obtained.

### Experimental Example 4

In the present example, a chiffon cake was prepared and evaluated. Specifically, Example 4-1 was evaluated based on Control Example 4. Table 5 shows blending and evaluation results of each example.

(Method for producing chiffon cake)

1. Among the raw materials, the soft flour, the starch powder, the sugar, the skim milk powder, and the baking powder were put in a plastic bag and mixed to prepare a mixed flour. In Control Example, the soft flour, the sugar, the skim milk powder, and the baking powder were put in a plastic bag and mixed to obtain a mixed flour.

2. Each of the oil and fat products, whole eggs, and the mixed flour obtained in 1. was placed in a bowl and mixed with a hobart mixer equipped with a whisk at medium speed so that the specific gravity was 0.49 to 0.51.

3. 410 g of the mixed dough was put into a chiffon mold having a diameter of 20 cm and baked in an oven under the following conditions.

Baking conditions: Upper part 180° C./Lower part 180° C.

Baking time: 30 minutes

4. The baked chiffon cake was taken out from the mold, and the whipped cream prepared by the same method as (Method for producing decoration cake) was applied to the entire surface except for the bottom surface of the cake to have a thickness of about 5 mm to obtain a decoration chiffon cake.

5. The obtained decoration chiffon cake was placed in a chiffon cake paper box (dimensions: 256×256×155 mm) and stored at 4° C. for 3 days.

6. The cake was taken out of the box, divided into 8 equal parts, eaten, and evaluated.

TABLE 5

| | | Control | |
|---|---|---|---|
| | | Exam- | Exam- |
| | | ple 4 | ple 4-1 |
| Kind of starch powder | | — | Starch |
| | | | pow- |
| | | | der 2 |
| Blending (part(s) by mass) | | | |
| Powder | Sugar | 100 | 100 |
| raw | Soft flour | 100 | 90 |
| material | Starch powder | 0 | 10 |
| | Baking powder | 2.1 | 2.1 |
| | Skim milk powder | 5 | 5 |
| Other raw | Oil and fat | 13 | 13 |
| material | product 2 | | |
| | Oil and fat | 44 | 44 |
| | product 3 | | |
| | Who1e egg (net | 150 | 150 |
| | content) | | |

| | | |
|---|---|---|
| Total | 414.1 | 414.1 |
| (Starch powder/(Powder raw | 0 | 4.83 |
| material + Starch powder)) | | |
| (Starch powder/(Cereal flour + | 0 | 10.0 |
| Starch powder)) | | |

When the whipped decoration chiffon cake of Example 4-1 was eaten, since the chiffon cake contains the starch powder 2, the degree of dryness of the chiffon cake portion after storage at 4° C. for 3 days and the meltability in mouth of the chiffon cake portion were excellent as compared with the whipped decoration chiffon cake of Control Example 4. In addition, the whipped decoration chiffon cake of Example 4-1 was excellent in the balance of meltability in mouth between the whipped cream and the chiffon cake after storage at 4° C. for 3 days.

### Preparation Example 1 of Mixed Flour

The starch powder 2 was used as the component (A). 40 g of the starch powder 2 and 460 g of a soft flour were mixed to obtain the mixed flour of the present example.

From the above, in the sponge cake or the chiffon cake using the improver for a sponge cake of each example, the degree of dryness of the sponge cake and the meltability in mouth of the sponge portion after storage at 4° C. for 3 days were excellent. In addition, the decoration cake obtained by coating the sponge cake or the chiffon cake of each example with a cream was excellent in the balance of the meltability in mouth between the whipped cream and the sponge cake after storage at 4° C. for 3 days.

### Experimental Example 5

In the present example, a roll cake was prepared and evaluated. Specifically, Examples 5-1 and 5-2 were evaluated based on Control Example 5. Table 6 shows blending and evaluation results of each example.

A roll cake was obtained by the following procedure.

(Method for producing sponge cake by all-in-mix method)

1. Among the raw materials, the starch powder and the baking powder were previously mixed to prepare an improver for a sponge cake.

2. The soft flour and the sugar were put into a plastic bag and mixed, and the improver for a sponge cake prepared in 1. was further added thereto to obtain a mixed flour. In Control Example, the soft flour, the sugar, and the baking powder were put in a plastic bag and mixed to obtain a mixed flour.

3. The other raw materials and the mixed flour obtained in above 2. was placed in a bowl and mixed with a hobart mixer equipped with a whisk at medium speed so that the specific gravity was 0.32 to 0.36.

4. 550 g of a dough after mixed was placed on an 8-top plate (dimensions: 350×400 mm) and baked in an oven under the following conditions.

Baking conditions: Upper part 180° C./Lower part 180° C.

Baking time: 12 minutes

(Decoration method for roll cake)

In Examples 5-1 and 5-2 and Control Example 5, a whipped cream was prepared by the following method and squeezed to obtain a fresh cream roll cake of each example.

1. One pack of fresh cream was placed in a bowl, 16 g of white sugar was added, and the mixture was whipped at medium speed with a mixer to obtain an 80% stiff whipped cream.

2. The whipped cream was evenly applied to the sponge cake of each example after baking with a palette knife to have a thickness of 5 to 6 mm.

3. A surface of the sponge cake coated with the cream in above 2. was rolled inward and formed into a tubular shape to obtain a roll cake.

4. The obtained roll cake was placed in a plastic packaging bag (dimensions: 100×100 mm), closed with a sealer, and stored at 4° C. for 3 days.

5. The cake was taken out of the bag, eaten, and evaluated by a consensus of three specialized panelists in accordance with the evaluation method for the decoration cake described above.

TABLE 6

| | | Control | | |
|---|---|---|---|---|
| | | Exam- | Exam- | Exam- |
| | | ple 5 | ple 5-1 | ple 5-2 |
| Kind of starch powder | | — | Starch | Starch |
| | | | pow- | pow- |
| | | | der 2 | der 2 |
| Blending (part(s) by mass) | | | | |
| Powder | Soft flour | 80 | 60 | 60 |
| raw | Starch powder | | 20 | 20 |
| material | Sugar | 60 | 60 | 90 |
| | Baking powder | 1.5 | 1.5 | 1.5 |
| Other raw | Whole egg | 240 | 240 | 240 |
| material | Egg yolk | 40 | 40 | 40 |
| | Honey | 30 | 30 | 0 |
| | Water | 60 | 60 | 60 |
| | Oil and fat | 50 | 50 | 50 |
| | product 1 | | | |
| | Oil and fat | 30 | 30 | 30 |
| | product 2 | | | |
| Total | | 591.5 | 591.5 | 591.5 |
| (Starch powder/(Powder raw material + | | — | 14.1 | 11.7 |
| Starch powder)) | | | | |
| (Starch powder/(Cereal flour + Starch | | — | 25.0 | 25.0 |
| powder)) | | | | |
| Evaluation | Degree of | 3.0 | 4.0 | 3.5 |
| score | dryness of | | | |
| | sponge cake | | | |
| | Feeling of | 3.0 | 4.5 | 4.0 |
| | meltability | | | |
| | in mouth of | | | |
| | sponge cake | | | |
| | portion | | | |
| | Balance of | 3.0 | 5.0 | 5.0 |
| | feeling of | | | |
| | meltability | | | |
| | in mouth | | | |
| | between | | | |
| | whipped | | | |
| | cream and | | | |
| | sponge cake | | | |

From Table 6, also in the roll cake, in Examples 5-1 and 5-2 to which the starch powder 2 was added, the roll cake in which the dryness of the sponge cake was suppressed, meltability in mouth of the sponge cake portion was excellent, and the balance of the meltability in mouth between the whipped cream and the sponge cake was also excellent was obtained even when storage at 4° C. for 3 days.

(Decoration Example 1 of roll cake)

A sponge cake was prepared according to the procedure of Experimental Example 5. The sponge cake was cut into 22 cm in length and 2.2 cm in width, and placed inside a paper cupcake mold (size: bottom diameter 75×height 22.5 mm) in a circular motion, and 25 g of whipped cream obtained by the same method as in Experimental Example 5 was squeezed out to an open portion at the center to obtain a roll cake. The roll cake was placed in a plastic wrapping bag (dimensions: 100×100 mm), closed with a sealer, store at 4° C. for 3 days, and then eaten. As a result, the dryness was suppressed and the meltability in mouth of the sponge portion is good, and the balance of the meltability in mouth between the whipped cream and the sponge cake was also excellent.

### Experimental Example 6

In the present example, a sponge cake was prepared by the following method. Table 7 shows raw materials and blending of each example.

(Method for producing sponge cake by all-in-mix method)

1. Among the raw materials, the soft flour, the starch powder, the sugar, and the baking powder were put in a plastic bag and mixed to prepare a mixed flour. In Control Example, the soft flour, the sugar, and the baking powder were put in a plastic bag and mixed to obtain a mixed flour.

2. Whole eggs, each of the oil and fat products, the sugar liquid, and the mixed flour obtained in 1. was placed in a bowl and mixed with a hobart mixer equipped with a whisk at medium speed so that the specific gravity was 0.40 to 0.43.

3. 280 g of the mixed dough was put into a No. 6 round mold and baked in an oven under the following conditions.

Baking conditions: Upper part 180° C./Lower part 180° C.

Baking time: 27 minutes

4. The obtained sponge cake was completely cooled, and then was placed in a plastic bag, sealed, and stored at 20° C. for 7 days.

TABLE 7

| | | Control | | |
|---|---|---|---|---|
| | | Exam- | Exam- | Exam- |
| | | ple 6 | ple 6-1 | ple 6-2 |
| Kind of starch powder | | — | Starch | Starch |
| | | | pow- | pow- |
| | | | der 2 | der 2 |
| Blending Part(s) by mass | | | | |
| Powder | Sugar | 110 | 110 | 110 |
| raw | Soft flour | 100 | 90 | 90 |
| material | Starch powder | | 10 | 10 |
| | Baking powder | 2 | 2 | 2 |
| Other raw | Sugar liquid | 15 | 15 | 15 |
| material | Oil and fat | 20 | 20 | 20 |
| | product 2 | | | |
| | Oil and fat | 30 | 30 | 30 |
| | product 4 | | | |
| | Whole egg | 240 | 240 | 250 |

| | | | |
|---|---|---|---|
| Total | 517 | 517 | 527 |
| (Starch powder/(Powder raw | 0 | 4.72 | 4.72 |
| material + Starch powder)) | | | |
| (Starch powder/(Cereal flour + | 0 | 10.0 | 10.0 |
| Starch powder)) | | | |

The sponge cakes obtained in each of the examples described in Table 7 were evaluated. As a result, all of the sponge cakes obtained in Examples 6-1 and 6-2 to which the starch powder 2 was added were soft and had good texture of the meltability in mouth, even when storage at a normal temperature for 7 days, as compared with the sponge cake of Control Example 6. Also, in Example 6-2, the moist feeling was further excellent.

Priority is claimed on Japanese Patent Application No. 2018-147044, filed on Aug. 3, 2018, and Japanese Patent Application No. 2018-197308, filed on Oct. 19, 2018, the entire disclosures of which are incorporated herein.

1. An improver for a sponge cake, comprising:
a component (A) satisfying conditions of (1) to (5) below as an active ingredient,
(1) a starch content is equal to or more than 75% by mass,
(2) equal to or more than 3% by mass and equal to or less than 45% by mass of molecular weight-reduced starch of starch having an amylose content of equal to or more than 5% by mass is contained, where the molecular weight-reduced starch has a peak molecular weight of equal to or more than 3×10³ and equal to or less than 5×10⁴,
(3) a degree of swelling in cold water at 25° C. is equal to or more than 5 and equal to or less than 20,
(4) a content under a sieve having a mesh size of 0.25 mm is equal to or more than 80% by mass and equal to or less than 100% by mass, and
(5) a content on a sieve having a mesh size of 0.5 mm is equal to or less than 10% by mass.

2. The improver for a sponge cake according to claim 1,
wherein the starch having an amylose content of equal to or more than 5% by mass is corn starch having an amylose content of equal to or more than 40% by mass.

3. The improver for a sponge cake according to claim 1 or 2,
wherein the molecular weight-reduced starch is one or more selected from the group consisting of acid-treated starch, oxidation-treated starch, and enzyme-treated starch.

4. The improver for a sponge cake according to claim 1,
wherein the component (A) contains, as starch other than the molecular weight-reduced starch, one ore more selected from the group consisting of corn starch, wheat starch, potato starch, tapioca starch, and crosslinked starch.

5. The improver for a sponge cake according to claim 1,
wherein a content of the component (A) under a sieve having a mesh size of 0.25 mm and on a sieve having a mesh size of 0.075 mm is equal to or more than 30% by mass and equal to or less than 100% by mass.

6. The improver for a sponge cake according to claim 1,
wherein a content of the component (A) under a sieve having a mesh size of 0.075 mm is equal to or more than 50% by mass and equal to or less than 100% by mass.

7. A dough for a sponge cake comprising:
a component (A) satisfying conditions of (1) to (5) below; and
a powder raw material other than the component (A),
(1) a starch content is equal to or more than 75% by mass,
(2) equal to or more than 3% by mass and equal to or less than 45% by mass of molecular weight-reduced starch of starch having an amylose content of equal to or more than 5% by mass is contained, where the molecular weight-reduced starch has a peak molecular weight of equal to or more than 3×10³ and equal to or less than 5×10⁴,
(3) a degree of swelling in cold water at 25° C. is equal to or more than 5 and equal to or less than 20,
(4) a content under a sieve having a mesh size of 0.25 mm is equal to or more than 80% by mass and equal to or less than 100% by mass, and
(5) a content on a sieve having a mesh size of 0.5 mm is equal to or less than 10% by mass.

8. The dough for a sponge cake according to claim 7,
wherein a content of the component (A) with respect to a total content of the powder raw material and the component (A) in the dough for a sponge cake is equal to or more than 0.3% by mass and equal to or less than 25% by mass.

9. The dough for a sponge cake according to claim 7-GF-8,
wherein the powder raw material contains a cereal flour.

10. A mixed flour for a sponge cake, comprising:
a component (A) satisfying conditions of (1) to (5) below; and
one or two selected from a cereal flour and sugars,
(1) a starch content is equal to or more than 75% by mass,
(2) equal to or more than 3% by mass and equal to or less than 45% by mass of molecular weight-reduced starch of starch having an amylose content of equal to or more than 5% by mass is contained, where the molecular weight-reduced starch has a peak molecular weight of equal to or more than 3×10³ and equal to or less than 5×10⁴,
(3) a degree of swelling in cold water at 25° C. is equal to or more than 5 and equal to or less than 20,
(4) a content under a sieve having a mesh size of 0.25 mm is equal to or more than 80% by mass and equal to or less than 100% by mass, and
(5) a content on a sieve having a mesh size of 0.5 mm is equal to or less than 10% by mass.

11. A sponge cake comprising:
a component (A) satisfying conditions of (1) to (5) below; and
a powder raw material other than the component (A),
(1) a starch content is equal to or more than 75% by mass,
(2) equal to or more than 3% by mass and equal to or less than 45% by mass of molecular weight-reduced starch of starch having an amylose content of equal to or more than 5% by mass is contained, where the molecular weight-reduced starch has a peak molecular weight of equal to or more than 3×10³ and equal to or less than 5×10⁴,
(3) a degree of swelling in cold water at 25° C. is equal to or more than 5 and equal to or less than 20,
(4) a content under a sieve having a mesh size of 0.25 mm is equal to or more than 80% by mass and equal to or less than 100% by mass, and
(5) a content on a sieve having a mesh size of 0.5 mm is equal to or less than 10% by mass.

12. The sponge cake according to claim 11,
wherein a content of the component (A) with respect to a total content of the powder raw material and the component (A) in the sponge cake is equal to or more than 0.3% by mass and equal to or less than 25% by mass.

13. The sponge cake according to claim 11 or 12,
wherein the powder raw material contains a cereal flour.

14. A method for producing a sponge cake, comprising:
a step of mixing a component (A) satisfying conditions of (1) to (5) below and a powder raw material other than the component (A) to obtain a dough; and
a step of baking the dough,
(1) a starch content is equal to or more than 75% by mass,
(2) equal to or more than 3% by mass and equal to or less than 45% by mass of molecular weight-reduced starch of starch having an amylose content of equal to or more than 5% by mass is contained, where the molecular weight-reduced starch has a peak molecular weight of equal to or more than 3×10³ and equal to or less than 5×10⁴,
(3) a degree of swelling in cold water at 25° C. is equal to or more than 5 and equal to or less than 20,
(4) a content under a sieve having a mesh size of 0.25 mm is equal to or more than 80% by mass and equal to or less than 100% by mass, and
(5) a content on a sieve having a mesh size of 0.5 mm is equal to or less than 10% by mass.

15. A method for producing a decoration cake, comprising:
a step of preparing the sponge cake according to claim 11; and
a step of coating the sponge cake.

16. The method for producing a decoration cake according to claim 15, further comprising:
a step of storing the sponge cake at a temperature of equal to or lower than 10° C. after the step of coating.

17. A method for suppressing dryness of a sponge cake, comprising:
incorporating a component (A) satisfying conditions of (1) to (5) below into a dough of the sponge cake,
(1) a starch content is equal to or more than 75% by mass,
(2) equal to or more than 3% by mass and equal to or less than 45% by mass of molecular weight-reduced starch of starch having an amylose content of equal to or more than 5% by mass is contained, where the molecular weight-reduced starch has a peak molecular weight of equal to or more than 3×10³ and equal to or less than 5×10⁴,
(3) a degree of swelling in cold water at 25° C. is equal to or more than 5 and equal to or less than 20,
(4) a content under a sieve having a mesh size of 0.25 mm is equal to or more than 80% by mass and equal to or less than 100% by mass, and
(5) a content on a sieve having a mesh size of 0.5 mm is equal to or less than 10% by mass.

18. The method according to claim 17,
wherein the dryness occurs at a temperature of equal to or lower than 10° C.

19. A method for improving, in a decoration cake in which a sponge cake is coated with a whipped cream, a balance of meltability in mouth between the cream and the sponge cake, the method comprising:
incorporating a component (A) satisfying conditions of (1) to (5) below into a dough of the sponge cake,
(1) a starch content is equal to or more than 75% by mass,
(2) equal to or more than 3% by mass and equal to or less than 45% by mass of molecular weight-reduced starch of starch having an amylose content of equal to or more than 5% by mass is contained, where the molecular weight-reduced starch has a peak molecular weight of equal to or more than 3×10³ and equal to or less than 5×10⁴,
(3) a degree of swelling in cold water at 25° C. is equal to or more than 5 and equal to or less than 20,
(4) a content under a sieve having a mesh size of 0.25 mm is equal to or more than 80% by mass and equal to or less than 100% by mass, and
(5) a content on a sieve having a mesh size of 0.5 mm is equal to or less than 10% by mass.
